(19) United States
(12) Patent Application Publication
(10) Pub. No.: US 2020/0082349 A1
(43) Pub. Date: Mar. 12, 2020

(54) Blockchain Timeclock System

(71) Applicant: ADP, LLC, Roseland, NJ (US)

(72) Inventor: Mitchel Jon Maio, Moorpark, CA (US)

(21) Appl. No.: 16/124,525

(22) Filed: Sep. 7, 2018

(51) Int. Cl. G06Q 10/10

(52) U.S. Cl. CPC G06Q 10/1091; G06F 21/60

(57) ABSTRACT

A method, computer system, and computer program product are provided for tracking work hours for employees within a blockchain timeclock system. A blockchain timeclock system receives a time capture event that identifies an account of an employee in the blockchain timeclock system. The blockchain timeclock system records the time capture event in a blockchain. The blockchain timeclock system determines whether a smart contract recorded within the timeclock blockchain permits the time capture event. Responsive to determining that a smart contract permits the time capture event, the timeclock blockchain system updates a state of the account of the employee in the blockchain timeclock system to reflect the time capture event. Responsive to determining that the smart contract permits the time capture event, the timeclock blockchain system communicates the time capture event to a timekeeper service to record timeclock information for the employee.

### BACKGROUND INFORMATION

### 1. Field

The present disclosure relates to use of payroll smart contracts implemented solely in a computer network for use with distributed ledgers.

### 2. Background

A distributed ledger, as used throughout this document, refers to a computer-only technology that enables a distributed recordation of transactions through the distributed ledger maintained by a network of computers. A blockchain is an example of a distributed ledger. BITCOIN® is an example of a blockchain technology application.

A blockchain is a type of distributed ledger, which includes digitally-recorded, unmodifiable data in packages called blocks. A distributed ledger is a consensus of replicated, shared, and synchronized digital data geographically spread across multiple computers which may be in different sites, countries, and/or institutions maintained by many different parties. A distributed ledger can be public, such as BITCOIN®, where there is no limitation on who may participate in the network, or private, where only approved parties are permitted to participate in the network.

### SUMMARY

The illustrative embodiments provide for a method for controlling access to a licensed software application. A computer system receives an access request from a user that requests access to the licensed software application. The computer system determines whether a user has accepted license terms for a current version of the licensed software application by querying a version control blockchain. Responsive to determining that user has not accepted the license terms for the current version of the licensed software application, the computer system presents the user with a clickwrap agreement requiring the user to accept license terms for the current version of the licensed software application. Responsive to receiving acceptance of the license terms from the user, the computer system records the user's acceptance of the license terms for the current version of the licensed software application in the version control blockchain.

The illustrative embodiments also contemplate a computer configured to execute program code which implements this method. The illustrative embodiments also contemplate a non-transitory computer-recordable storage medium storing program code, which, when executed, implements this method.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a distributed ledger in the form of a blockchain in accordance with an illustrative embodiment;

FIG. 2 is an illustration of a first step in creating a blockchain in accordance with an illustrative embodiment;

FIG. 3 is an illustration of a second step in creating a blockchain in accordance with an illustrative embodiment;

FIG. 4 is an illustration of a third step in creating a blockchain in accordance with an illustrative embodiment;

FIG. 5 is an illustration of a fourth step in creating a blockchain in accordance with an illustrative embodiment;

FIG. 6 is an illustration of a fifth step in creating a blockchain in accordance with an illustrative embodiment;

FIG. 7 is an illustration of a sixth step in creating a blockchain in accordance with an illustrative embodiment;

FIG. 8 is an illustration of a creation of a smart contract in accordance with an illustrative embodiment;

FIG. 9 is an illustration of an operation of a smart contract in accordance with an illustrative embodiment;

FIG. 10 is a block diagram of an execution environment for executing a smart contract stored on a blockchain in accordance with an illustrative embodiment;

FIG. 11 is a block diagram of a blockchain timeclock environment in accordance with an illustrative embodiment;

FIG. 12 is a flowchart of a process for controlling access to a licensed software application in accordance with an illustrative embodiment; and

FIG. 13 is a block diagram of a data processing system in accordance with an illustrative embodiment.

### DETAILED DESCRIPTION

The illustrative embodiments recognize and take into account that smart contracts on blockchains have not been used to track employee working hours. In other words, so far, no one has attempted to or designed a timeclock system that utilizes the underlying technology of blockchains and smart contracts to create an open and secure timeclock system.

A distributed ledger, as used throughout this document, refers to a computer-only technology that enables the distributed recordation of transactions through a distributed ledger maintained by a network of computers. A blockchain is an example of a distributed ledger. BITCOIN® is an example of a blockchain technology application.

A blockchain is a type of distributed ledger, which includes digitally recorded, unmodifiable data in packages called blocks. A distributed ledger is a consensus of replicated, shared, and synchronized digital data geographically spread across multiple computers which may be in different sites, countries, and/or institutions maintained by many different parties. A distributed ledger can be public, such as BITCOIN®, where there is no limitation on who may participate in the network, or private, where only approved parties are permitted to participate in the network.

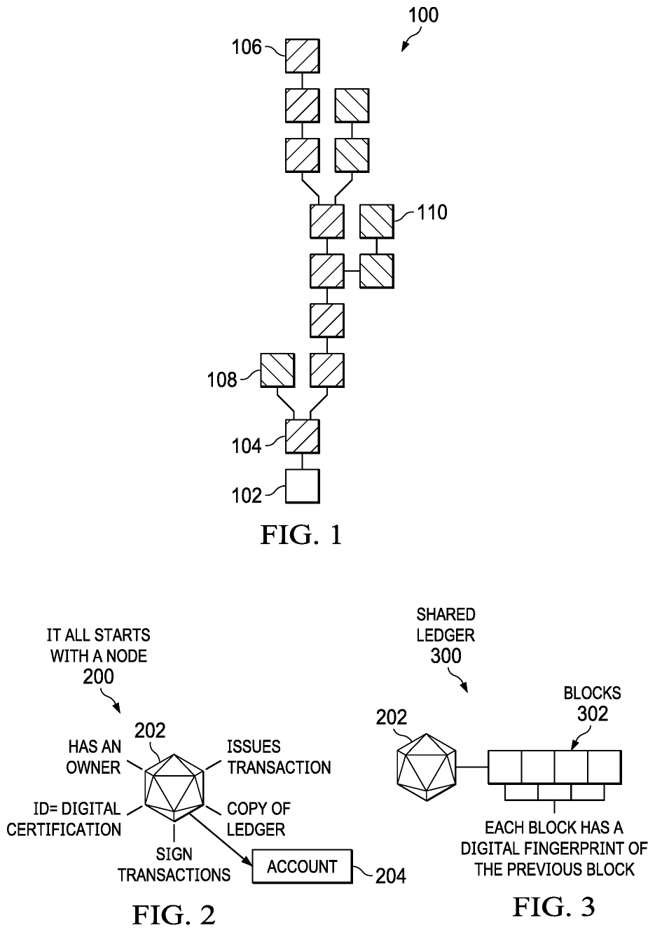

FIG. 1 is an illustration of a distributed ledger in the form of a blockchain depicted in accordance with an illustrative embodiment. Blockchain 100 is a blockchain, which is a specific implementation of a distributed ledger. Blockchain 100 is described to introduce blockchain concepts.

Blockchain 100 starts with genesis block 102. Blocks indicated with a right-leaning hash, such as block 104 or block 106, are part of the main chain. Blocks with a left-leaning hash, such as block 108 or block 110, exist outside of blockchain 100.

Thus, blockchain 100 is a heaviest path from root block 102 to leaf block 106 through the entire block tree. The “heaviest” path through the block tree, i.e. the path that has had the most computation done upon it, is conceptually identified as blockchain 100. Identifying blockchain 100 in this manner allows a decentralized consensus to be achieved for the state of blockchain 100.

Stated more formally, a blockchain is a distributed database that maintains a continuously growing list of ordered records called blocks. Each block contains a timestamp and a link to a previous block, with the hash of the prior block linking the two. By design, blockchains are inherently resistant to modification of the data because, once recorded, the data in a block cannot be altered retroactively. Through the use of a peer-to-peer network and one or more distributed timestamping servers, a blockchain database may be managed autonomously. Thus, blockchains may be used to provide an open, distributed ledger that can record transactions between parties efficiently and in a verifiable and permanent way.

Distributed ledgers, and blockchains in particular, are secure by design. Blockchains have a high byzantine fault tolerance. Thus, a decentralized consensus can be achieved with a blockchain. The first blockchain was created by Satoshi Nakamoto in 2008 and implemented the following year as a core component of the digital currency BITCOIN®, where it serves as the public ledger for all transactions. BITCOIN® was the first digital currency to solve the double spending problem, without the use of a trusted authority or central server.

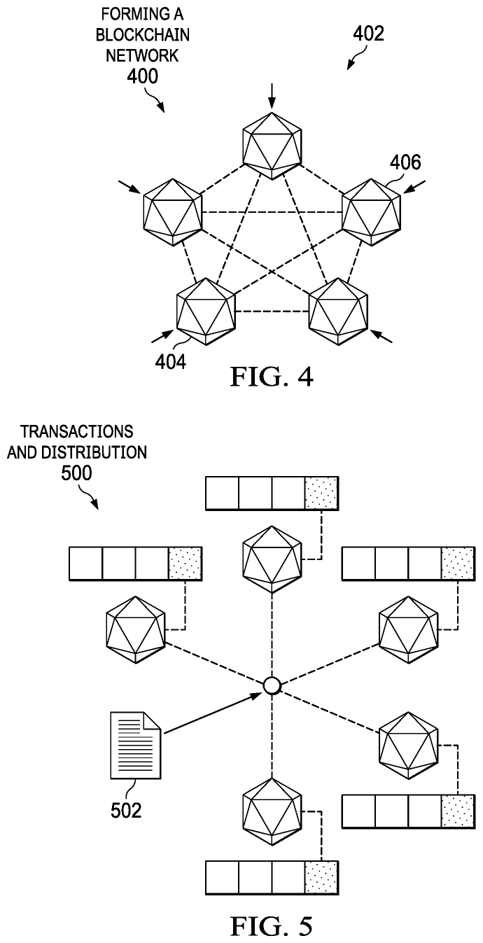

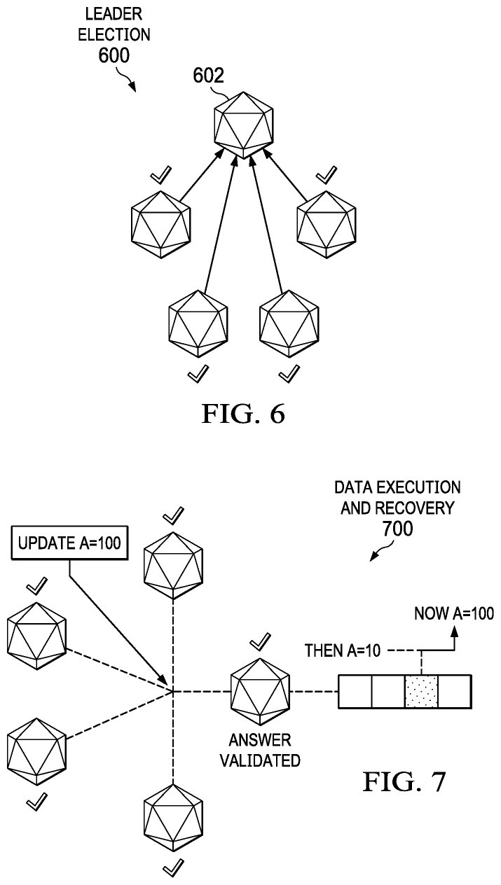

FIG. 2 through FIG. 7 should be considered together. FIG. 2 is an illustration of a first step in creating a blockchain in accordance with an illustrative embodiment. FIG. 3 is an illustration of a second step in creating a blockchain in accordance with an illustrative embodiment. FIG. 4 is an illustration of a third step in creating a blockchain in accordance with an illustrative embodiment. FIG. 5 is an illustration of a fourth step in creating a blockchain in accordance with an illustrative embodiment. FIG. 6 is an illustration of a fifth step in creating a blockchain in accordance with an illustrative embodiment. FIG. 7 is an illustration of a sixth step in creating a blockchain in accordance with an illustrative embodiment. FIG. 2 through FIG. 7 may be implemented on a computer or on multiple computers in a network environment. FIG. 2 through FIG. 7 address a technical problem that only exists in computer programming and execution. As used throughout FIG. 2 through FIG. 7, common reference numerals refer to common objects in these figures.

In operation 200 shown in FIG. 2, node 202 creates account 204 that contains initial data for a distributed ledger. Account 204 is a state object recorded in a shared ledger that represents the identity of agents that can interact with the ledger. Account 204 includes an owner, a digital certificate identification, and a copy of a ledger. Node 202 may issue transactions from account 204 for interacting with the blockchain. Node 202 may sign transactions and inspect the blockchain and its associated state. The state of a blockchain is the combined state of all nodes that have interacted with the blockchain. Node 202 may issue transactions from account 204 for interacting with the blockchain.

In operation 300 shown in FIG. 3, node 202 collates transactions and distributions into blocks 302, and adds blocks 302 to the shared ledger. Blocks 302 function as a journal, recording a series of transactions together with the previous block and an identifier for the final state of the blockchain. Blocks 302 are chained together using a cryptographic hash as a means of reference—each block in the shared ledger has a digital fingerprint of the previous block. In this manner, it is not possible to alter previous blocks without being detected.

In operation 400 shown in FIG. 4, blockchain network 402 is formed. Blockchain network 402 may include multiple blockchains such as those shown in FIG. 2 or FIG. 3. Each node, such as node 404 or node 406, has its own blockchain.

In operation 500 shown in FIG. 5, transaction 502 is issued from an account, such as account 204 in FIG. 2. Transaction 502 is an instruction constructed by a node, such as node 202 in FIG. 2, and cryptographically-signed by an account, such as account 204.

There are two types of transactions: transactions that result in message calls, and transactions that result in the creation of new agent accounts, i.e., “contract creation” transactions. Transactions are that result in message calls contain data specifying input data for the message.

Transactions and distributions are collated into blocks that are added to the blockchain by the various nodes. The blockchain is synchronized across the various nodes. Thus, each node in blockchain network 402 in FIG. 4 adds identical blocks to a local copy of the blockchain.

In operation 600 shown in FIG. 6, leader election takes place. In this operation, leader node 602 is elected. Leader node 602 takes priority for deciding which information is the most accurate or up-to-date. Identifying information by leader node 602, and validating this information by other nodes, allows a decentralized consensus to be achieved throughout the network for the state of blockchain 100 in FIG. 1.

In operation 700 shown in FIG. 7, data execution and recovery takes place. A query regarding data stored in one or more of the nodes may return a validated answer regarding contents in the blocks.

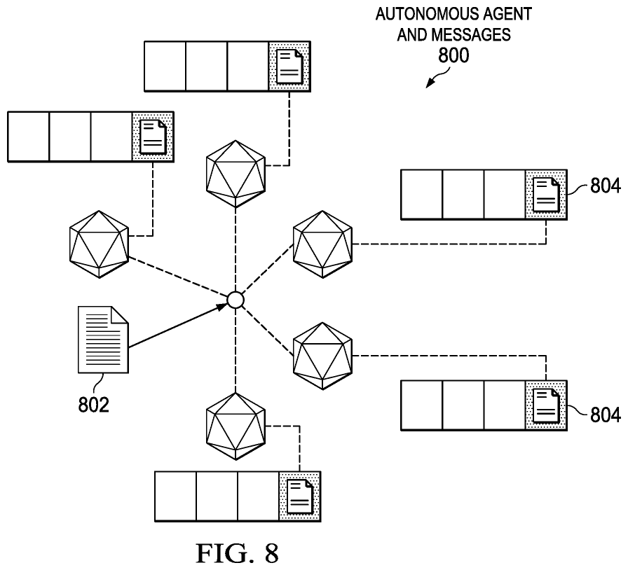

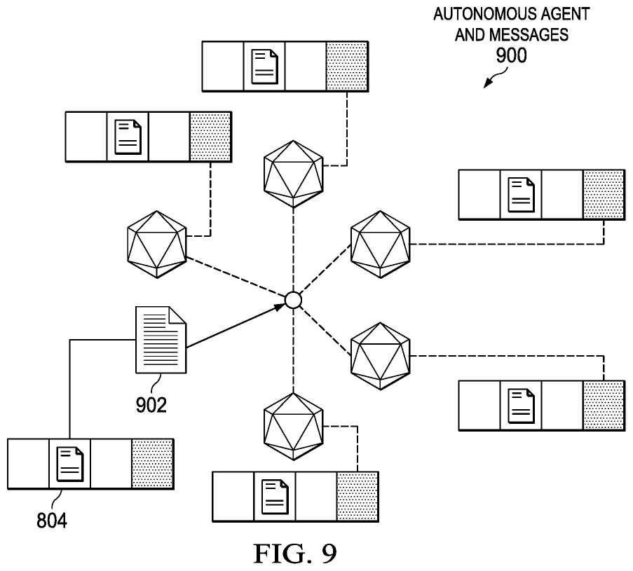

FIG. 8 and FIG. 9 should be considered together. FIG. 8 is an illustration of a step in creating a blockchain having a smart contract therein in accordance with an illustrative embodiment. FIG. 9 is an illustration of a step in creating a blockchain using a smart contract within a blockchain in accordance with an illustrative embodiment. FIG. 8 and FIG. 9 may be implemented on a computer or on multiple computers in a network environment.

In operation 800 shown in FIG. 8, transaction 802 and distributions are added to the various nodes. Thus, blocks are added to each node. As indicated above, there are two types of transactions: transactions that result in message calls, and transactions that result in the creation of new agent accounts.

Transaction 802 is a cryptographically-signed instruction constructed by a node, such as node 202 in FIG. 2. Transaction 802 results in the creation of smart contract 804. In contrast to data contained in message call transactions, such as transaction 502 in FIG. 5, transaction 802 contains data specifying initialization code for smart contract 804. Each node in a blockchain network executes this initialization code to incorporate smart contract 804 into the blockchain. In this illustrative example, the initialization code is executed at account creation and discarded immediately thereafter. The initialization code retrieves a second code fragment of that executes each time the account receives a message call (either through a transaction or due to the internal execution of code).

Smart contract 804 is a type of account that is stored on the blockchain; it is a collection of code, i.e. functions, and data, i.e. state, that resides at a specific address on the blockchain. Smart contract 804 is not associated with an external node, but rather is a notional object existent only within the blockchain execution environment. Smart contract 804 has direct control over its own state and storage memory to preserve persistent state variables. When referenced by a message or transaction, smart contract 804 executes its associated functions.

In operation 900 shown in FIG. 9, smart contract 804 generates message 902. In a contract account, every time the contract account receives a message, its code activates. Message 902 is an instruction constructed by smart contract 804 in response to receiving a message. Message 902 is a sort of “virtual transaction” sent by code from one account to another. Message 902 can specify input data that results in message calls for other accounts, allowing smart contract 804 to read and write to internal storage. Alternatively, message 902 can contain data specifying initialization code, allowing smart contract 804 to create additional smart contracts.

In this illustrative example, code for smart contract 804 can be executed as part of state transition and block validation. If a transaction is added into a block, the code execution spawned by that transaction will be executed by all nodes that download and validate the block.

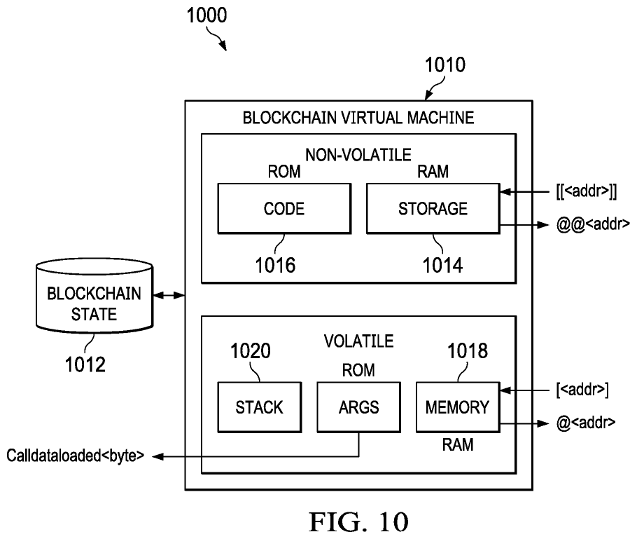

With reference next to FIG. 10, a block diagram of an execution environment for executing a smart contract stored on the blockchain is depicted in accordance with an illustrative embodiment.

Blockchain environment 1000 includes a number of different components. As depicted, blockchain environment 1000 includes blockchain virtual machine 1010 and blockchain state 1012.

Blockchain virtual machine 1010 is responsible for internal account state and transaction computation for the blockchain. Blockchain virtual machine 1010 performs state transitions for smart contracts. In this illustrative example, blockchain virtual machine 1010 has a stack-based architecture that uses a last-in, first-out stack. Blockchain virtual machine 1010 executes transactions recursively, computing the system state and the machine state for each loop. Blockchain virtual machine 1010 includes non-volatile and volatile components.

Storage 1014 is non-volatile and is maintained on the blockchain as part of the system state. Every smart contract on the blockchain has its own storage. Storage 1014 preserves all the state variables for the smart contract that do not change between the function calls.

Code 1016 are instructions that formally specify the meaning and ramifications of a transaction or message to an account. Blockchain virtual machine 1010 executes code 1016 in response to receiving a message call. In contrast to standard architecture where program code is stored in generally-accessible memory, code 1016 is stored separately in a virtual ROM that cannot be changed after construction.

Memory 1018 is volatile and is cleared between external function calls. Memory 1018 stores temporary data; for instance, function arguments, local variables, and storing return values. Stack 1020 is used to hold temporary values when conducting calculations in blockchain virtual machine 1010.

Blockchain environment 1000 includes blockchain state 1012. Blockchain virtual machine 1010 relies on blockchain state 1012 for execution of certain instructions. Blockchain state 1012 can include a mapping between blockchain addresses, i.e., accounts and account states. Blockchain state 1012 may not be stored on the blockchain, but rather in a data structure on a backend state database that maintains the mapping.

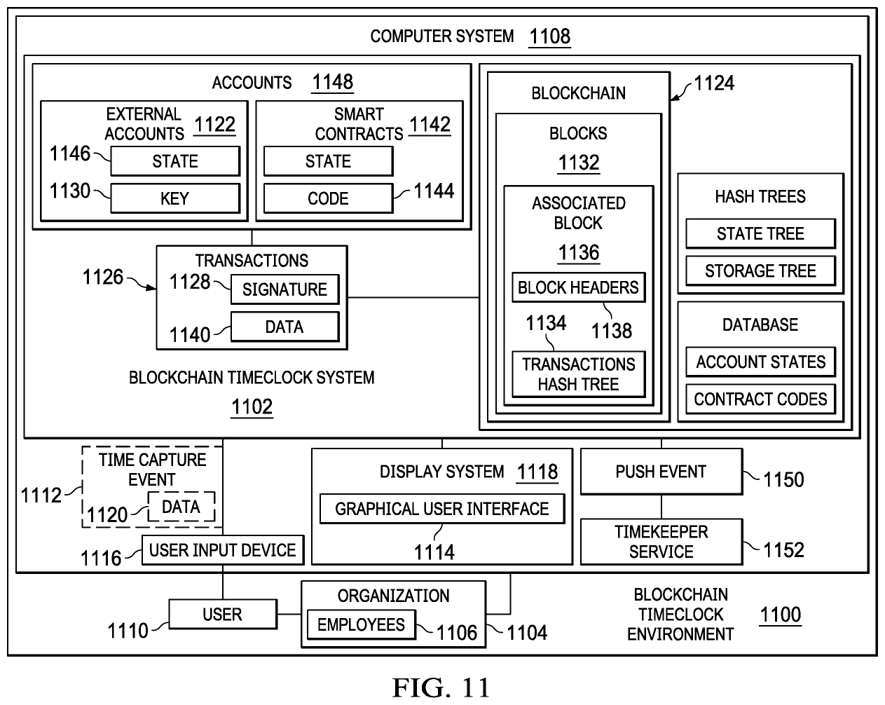

With reference now to FIG. 11, a block diagram of a blockchain timeclock environment is depicted in accordance with an illustrative embodiment. As depicted, blockchain timeclock environment 1100 includes blockchain timeclock system 1102.

Blockchain timeclock system 1102 may take different forms. For example, blockchain timeclock system 1102 may be selected from at least one of an employee information system, a research information system, a sales information system, an accounting system, a payroll system, a human resources system, or some other type of information system that records and stores time capture events and information.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, blockchain timeclock system 1102 manages time capture events for organization 1104. Organization 1104 may be, for example, a corporation, a partnership, a charitable organization, a city, a government agency, or some other suitable type of organization. Organization 1104 can encompass people who are employed by or associated with organization 1104, such as employees 1106.

In this illustrative example, blockchain timeclock system 1102 is implemented in computer system 1108. Computer system 1108 is a physical hardware system and includes one or more data processing systems. When more than one data processing system is present, those data processing systems may be in communication with each other using a communications medium. The communications medium may be a network. The data processing systems may be selected from at least one of a computer, a server computer, a workstation, a tablet computer, a laptop computer, a mobile phone, or some other suitable data processing system. The network of data processing systems are nodes within blockchain timeclock system 1102.

Blockchain timeclock system 1102 may be implemented in software, hardware, firmware, or a combination thereof. When software is used, the operations performed by blockchain timeclock system 1102 may be implemented in program code configured to run on hardware, such as a processor unit. When firmware is used, the operations performed by blockchain timeclock system 1102 may be implemented in program code and data and stored in persistent memory to run on a processor unit. When hardware is employed, the hardware may include circuits that operate to perform the operations in blockchain timeclock system 1102.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In this illustrative example, blockchain timeclock system 1102 tracks work hours for employees 1106 of organization 1104. User 1110, who can be one of employees 1106, may record work hours in with blockchain timeclock system 1102 by submitting time capture event 1112. Time capture event 1112 can be a clock-in or clock-out event that registers the beginning or ending of work hours by user 1110. Time capture event 1112 may be generated by user input to graphical user interface 1114 using one or more of user input device 1116, such as a keyboard, a mouse, a graphical user interface (a physical display), a touch screen, a voice interaction, and any other suitable interface for interacting with the computer.

In one illustrative example, blockchain timeclock system 1102 displays graphical user interface 1114 on display system 1118. In this illustrative example, display system 1118 can be a group of display devices. A display device in display system 1118 may be selected from one of a liquid crystal display (LCD), a light emitting diode (LED) display, an organic light emitting diode (OLED) display, and other suitable types of display devices.

Blockchain timeclock system 1102 receives time capture event 1112. Time capture event 1112 identifies an account of user 1110 in blockchain timeclock system 1102. In this illustrative example, time capture event 1112 includes data 1120. Data 1120 can include access control information, such as for example, one or more of a username, a password, or a unique device signature, that is associated with one of external accounts 1122 associated with user 1110.

In one illustrative example, user input device 1116 can be a mobile device. Blockchain timeclock system 1102 receives time capture event 1112 from a mobile device associated with user 1110. In this illustrative example, data 1120 of time capture event 1112 includes a mobile signature that uniquely identifies the mobile device associated with user 1110.

In one illustrative example, user input device 1116 can be a mobile device. Blockchain timeclock system 1102 receives time capture event 1112 from a mobile device associated with user 1110. In this illustrative example, data 1120 of time capture event 1112 includes location data that identifies a geographical location of the mobile device. In this illustrative example, data 1120 of time capture event 1112 includes a current time.

External accounts 1122 are examples of accounts 204 shown in block form in FIG. 2. External accounts 1122 allow external actors, such as user 1110, to interact with blockchain 1124 by issuing transactions 1126.

Transactions 1126 submitted from external accounts 1122 are cryptographically-signed by a respective account. For example, signature 1128 uniquely identifies key 1130 of the particular account that issues transactions 1126. For example, based on signature 1128 identifying a particular one of external accounts 1122, blockchain timeclock system 1102 is able to uniquely identify which of employees 1106 issues transactions 1126.

Blockchain timeclock system 1102 records time capture event 1112 in blockchain 1124. Time capture event 1112 is submitted to, and recorded in, blockchain timeclock system 1102 as one of transactions 1126 submitted from one of external accounts 1122. Blockchain timeclock system 1102 records transactions 1126 in blocks 1132 of blockchain 1124.

Each of transactions 1126 is hashed and stored in transactions hash tree 1134 of associated block 1136. All of the transaction hashes in transactions hash tree 1134 are themselves hashed and stored as a root hash as part of block headers 1138.

In this illustrative example, transactions 1126 issued by external accounts 1122 can include data 1140. Data 1140 specifies input data for one or more of smart contracts 1142. Data 1140 can include one or more pieces of information from data 1120.

Blockchain timeclock system 1102 determines whether one of smart contracts 1142, recorded within blockchain 1124, permits time capture event 1112. Smart contracts 1142 determine whether time capture event 1112 is permitted by executing code 1144, which can be code 1016 of FIG. 10.

Smart contracts have a number of desirable properties. Execution of the smart contract is managed automatically by the network. Documents are encrypted on a shared ledger that is duplicated many times over on different nodes of the network, ensuring that the data is true and correct. Because smart contracts on distributed ledgers cannot be modified, they provide an immutable record of submitted workflow transactions that is highly resistant to post-transaction changes. Smart contracts automate progression tasks that were previously performed manually, thereby saving time, possibly many hours.

In one illustrative example, data 1120 of time capture event 1112 includes a mobile signature that uniquely identifies a mobile device associated with user 1110. In this illustrative example, blockchain timeclock system 1102 determines whether smart contracts 1142 permit time capture event 1112 by determining whether the mobile signature for the mobile device that sent time capture event 1112 is associated with external accounts 1122 of the employee in blockchain timeclock system 1102. Responsive to determining that the mobile signature is associated with the account of the employee, blockchain timeclock system 1102 permits time capture event 1112.

In one illustrative example, data 1120 of time capture event 1112 includes location data that identifies a geographical location of a mobile device associated with user 1110. In this illustrative example, blockchain timeclock system 1102 determines whether smart contracts 1142 permit time capture event 1112 by determining whether the geographical location of the mobile device that sent the time capture event is within a permitted geographical area for accepting time capture events. Responsive to determining that the geographical location is within a permitted geographical area, blockchain timeclock system 1102 permits time capture event 1112.

In one illustrative example, data 1120 of time capture event 1112 includes a current time. In this illustrative example, blockchain timeclock system 1102 determines whether smart contracts 1142 permit time capture event 1112 by determining whether the current time sent in the time capture event is within a permitted time window for accepting time capture events. Responsive to determining that the current time is within the permitted time window, blockchain timeclock system 1102 permits time capture event 1112.

Responsive to determining that smart contracts 1142 permit time capture event 1112, blockchain timeclock system 1102 updates state 1146 of the account of the employee in blockchain timeclock system 1102 to reflect time capture event 1112. Accounts 1148, including external accounts 1122, are state objects recorded in blockchain 1124. Blockchain timeclock system 1102 can set state 1146 of external accounts 1122 in response to determining that smart contracts 1142 permit time capture event 1112 by user 1110. For example, upon determining that smart contracts 1142 permit time capture event 1112, blockchain timeclock system 1102 may set state 1146 to indicate a clocked-in or clocked-out state for user 1110.

Additionally, responsive to determining that the employee is permitted to perform the time capture event, blockchain timeclock system 1102 communicates time capture event 1112 to timekeeper service 1152 to record timeclock information for the employee.

In this illustrative example, smart contracts 1142 can generate one or more additional ones of transactions 1126 in response to the execution of code 1144. These additional ones of transactions 1126 can be transactions that are sent to other ones of accounts 1148 in blockchain timeclock system 1102. For example, smart contracts 1142 may generate transactions 1126 addressed to one or more of external accounts 1122 associated with organization 1104. In this illustrative example, data 1140 of transactions 1126 generated by smart contracts 1142 can include timeclock information relevant to the permitted one of time capture event 1112.

Transactions 1126 generated by smart contracts 1142 can request external accounts 1122 to generate external events, such as push event 1150. In this illustrative example, push event 1150 communicates time capture event 1112 to timekeeper service 1152, enabling timekeeper service 1152 to record timeclock information for the employee.

In one illustrative example, timekeeper service 1152 is associated with an account, such as one of external accounts 1122, of an employer, such as organization 1104, in blockchain timeclock system 1102. Blockchain timeclock system 1102 communicates time capture event 1112 to timekeeper service 1152 through push event 1150. Push event 1150 can be, for example, a web hook, a web socket, or some other appropriate communication that communicates timeclock information to timekeeper service 1152.

For example, blockchain timeclock system 1102 associates a URL address for timekeeper service 1152 with the account of the employer in blockchain timeclock system 1102. In response to permitting time capture event 1112, blockchain timeclock system 1102 pushes a POST request to timekeeper service 1152. The POST request can comprise a JSON object that includes timeclock information relevant to the permitted one of time capture event 1112, such as data 1120 of time capture event 1112.

The illustrative example in FIG. 11 and the examples in the other subsequent figures provide one or more technical solutions that address one or more technical problems that only exists in computers, particularly a network-centric system of computers. Specifically, blockchain timeclock system 1102 provides an immutable record of time capture event 1112. In this manner, the use of blockchain timeclock system 1102 has a technical effect of reporting time capture event 1112 using blockchain 1124, thereby reducing time, effort, or both in the accurate and extensive record-keeping necessary to effectively maintain records of employees' worked hours. In this manner, maintaining accurate records of time capture event 1112 may be performed more efficiently as compared to currently used systems that do not include blockchain timeclock system 1102.

As a result, computer system 1108 operates as a special purpose computer system in which blockchain timeclock system 1102 in computer system 1108 records time capture event 1112. Blockchain timeclock system 1102 receives a time capture event that identifies an account of an employee in blockchain timeclock system. Blockchain timeclock system 1102 records time capture event in a timeclock blockchain. Blockchain timeclock system 1102 determines whether a smart contract recorded within the timeclock blockchain permits the time capture event. Responsive to determining that the smart contract permits the time capture event, blockchain timeclock system 1102 updates a state of the account of the employee in the blockchain timeclock system to reflect the time capture event. Responsive to determining that the employee is permitted to perform the time capture event, blockchain timeclock system 1102 communicates the time capture event to a timekeeper service to record timeclock information for the employee.

Thus, blockchain timeclock system 1102 transforms computer system 1108 into a special purpose computer system as compared to currently available general computer systems that do not have blockchain timeclock system 1102. Currently used general computer systems do not provide an immutable record of time capture event 1112, thereby reducing time, effort, or both in the accurate and extensive record-keeping necessary to effectively maintain records of employees' worked hours.

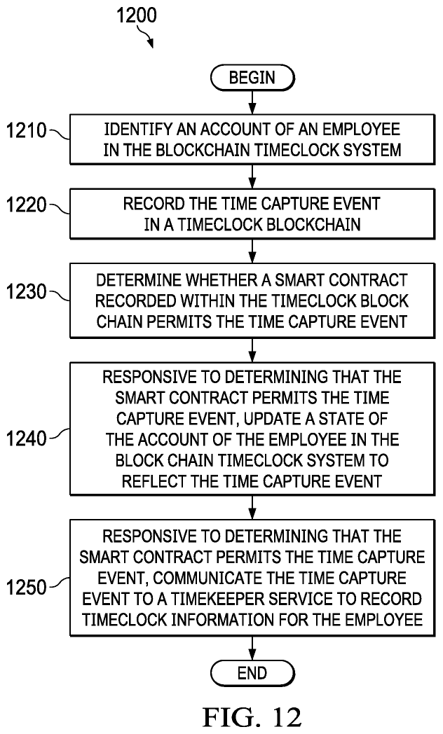

With reference next to FIG. 12, a flowchart of a process for tracking work hours for employees within a blockchain timeclock system is depicted in accordance with an illustrative embodiment. The process of FIG. 12 can be a software process implemented in one or more components of blockchain timeclock system 1102 of FIG. 11.

Process 1200 receives a time capture event that identifies an account of an employee in the blockchain timeclock system (step 1210). Process 1200 records a time capture event in a timeclock blockchain (step 1220).

Process 1200 determines whether a smart contract recorded within the timeclock blockchain permits the time capture event (step 1230).

Responsive to determining that the smart contract permits the time capture event, process 1200 updates a state of the account of the employee in the blockchain timeclock system to reflect the time capture event (step 1240).

Responsive to determining that the smart contract permits the time capture event, process 1200 communicates the time capture event to a timekeeper service to record timeclock information for the employee (step 1250), with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

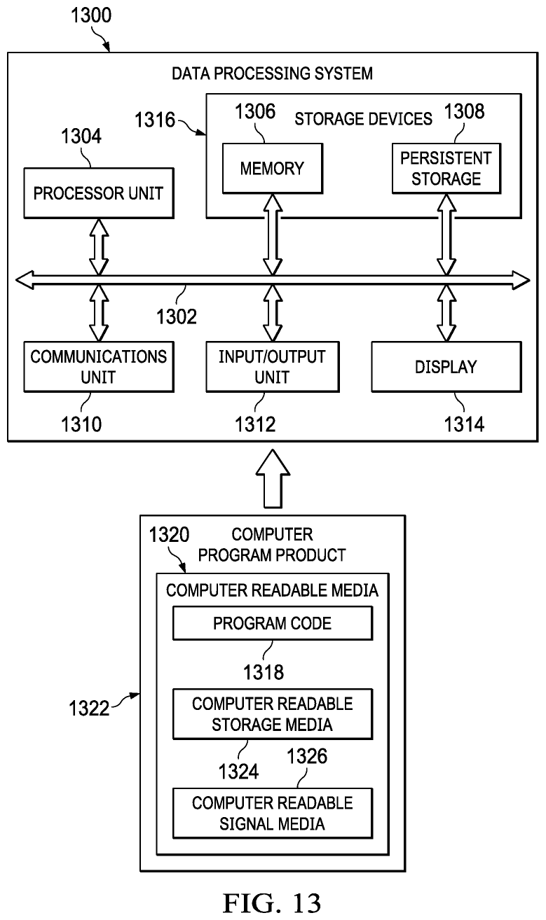

Turning now to FIG. 13, an illustration of a block diagram of a data processing system is depicted in accordance with an illustrative embodiment. Data processing system 1300 may be used to implement computer system 1108 and other data processing systems that may be used in blockchain timeclock environment 1100 in FIG. 11.

In this illustrative example, data processing system 1300 includes communications framework 1302, which provides communications between processor unit 1304, memory 1306, persistent storage 1308, communications unit 1310, input/output (I/O) unit 1328, and display 1314. In this example, communications framework 1302 may take the form of a bus system.

Processor unit 1304 serves to execute instructions for software that may be loaded into memory 1306. Processor unit 1304 may be a number of processors, a multi-processor core, or some other type of processor, depending on the particular implementation.

Memory 1306 and persistent storage 1308 are examples of storage devices 1316. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1316 may also be referred to as computer readable storage devices in these illustrative examples. Memory 1306, in these examples, may be, for example, a random access memory or any other suitable volatile or non-volatile storage device. Persistent storage 1308 may take various forms, depending on the particular implementation.

For example, persistent storage 1308 may contain one or more components or devices. For example, persistent storage 1308 may be a hard drive, a solid state hard drive, a flash memory, a rewritable optical disk, a rewritable magnetic tape, or some combination of the above. The media used by persistent storage 1308 also may be removable. For example, a removable hard drive may be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that may be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs may be located in storage devices 1316, which are in communication with processor unit 1304 through communications framework 1302. The processes of the different embodiments may be performed by processor unit 1304 using computer-implemented instructions, which may be located in a memory, such as memory 1306.

These instructions are referred to as program code, computer usable program code, or computer readable program code that may be read and executed by a processor in processor unit 1304. The program code in the different embodiments may be embodied on different physical or computer readable storage media, such as memory 1306 or persistent storage 1308.

Program code 1318 is located in a functional form on computer readable media 1320 that is selectively removable and may be loaded onto or transferred to data processing system 1300 for execution by processor unit 1304. Program code 1318 and computer readable media 1320 form computer program product 1322 in these illustrative examples. In one example, computer readable media 1320 may be computer readable storage media 1324 or computer readable signal media 1326.

In these illustrative examples, computer readable storage media 1324 is a physical or tangible storage device used to store program code 1318 rather than a medium that propagates or transmits program code 1318.

Alternatively, program code 1318 may be transferred to data processing system 1300 using computer readable signal media 1326. Computer readable signal media 1326 may be, for example, a propagated data signal containing program code 1318. For example, computer readable signal media 1326 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1300 are not meant to provide architectural limitations to the manner in which different embodiments may be implemented. The different illustrative embodiments may be implemented in a data processing system including components in addition to or in place of those illustrated for data processing system 1300. Other components shown in FIG. 13 can be varied from the illustrative examples shown. The different embodiments may be implemented using any hardware device or system capable of running program code 1318.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of tracking work hours for employees within a blockchain timeclock system, the method comprising:
receiving a time capture event that identifies an account of an employee in the blockchain timeclock system;
recording the time capture event in a timeclock blockchain;
determining whether a smart contract recorded within the timeclock blockchain permits the employee to perform the time capture event;
responsive to determining that the smart contract permits the time capture event, updating a state of the account of the employee in the blockchain timeclock system to reflect the time capture event; and
responsive to determining that the smart contract permits the time capture event, communicating the time capture event to a timekeeper service to record timeclock information for the employee.

2. The method of claim 1, wherein receiving the time capture event further comprises:
receiving the time capture event from a mobile device associated with the employee, wherein the time capture event includes a mobile signature that uniquely identifies the mobile device.

3. The method of claim 2, wherein determining whether the smart contract permits the time capture event further comprises:
determining whether the mobile signature for the mobile device that sent the time capture event is associated with the account of the employee in the blockchain timeclock system; and
responsive to determining that the mobile signature is associated with the account of the employee, permitting the time capture event.

4. The method of claim 1, wherein receiving the time capture event further comprises:
receiving the time capture event from a mobile device associated with the employee, wherein the time capture event includes location data that identifies a geographical location of the mobile device.

5. The method of claim 4, wherein determining whether the smart contract permits the time capture event further comprises:
determining whether the geographical location of the mobile device that sent the time capture event is within a permitted geographic area; and
responsive to determining that the geographical location is within a permitted geographic area, permitting the time capture event.

6. The method of claim 1, wherein receiving the time capture event further comprises:
receiving the time capture event from a mobile device associated with the employee, wherein the time capture event includes a current time.

7. The method of claim 4, wherein determining whether the smart contract permits the time capture event further comprises:
determining whether a current time sent in the time capture event is within a permitted time window; and
responsive to determining that the current time is within the permitted time window, permitting the time capture event.

8. The method of claim 1, wherein the timekeeper service is associated with an account of an employer in the blockchain timeclock system, the method further comprising:
associating a URL address for the timekeeper service with the account of the employer in the blockchain timeclock system; and
pushing a POST request to the timekeeper service, wherein the POST request comprises a JSON object that includes the time capture event.

9. A computer system comprising:
a hardware processor; and
a blockchain timeclock system in communication with the hardware processor, wherein the blockchain timeclock system is configured:
to receive a time capture event that identifies an account of an employee in the blockchain timeclock system;
to record the time capture event in a timeclock blockchain;
to determine whether a smart contract recorded within the timeclock blockchain permits the time capture event;
responsive to determining that the smart contract permits the time capture event, to update a state of the account of the employee in the blockchain timeclock system to reflect the time capture event; and
responsive to determining that the smart contract permits the time capture event, to communicate the time capture event to a timekeeper service to record timeclock information for the employee.

10. The computer system of claim 9, wherein in receiving the time capture event, the blockchain timeclock system is further configured:
to receive the time capture event from a mobile device associated with the employee, wherein the time capture event includes a mobile signature that uniquely identifies the mobile device.

11. The computer system of claim 10, wherein in determining whether the smart contract permits the time capture event, the blockchain timeclock system is further configured:
to determine whether the mobile signature for the mobile device that sent the time capture event is associated with the account of the employee in the blockchain timeclock system; and
responsive to determining that the mobile signature is associated with the account of the employee, to permit the time capture event.

12. The computer system of claim 9, wherein in receiving the time capture event, the blockchain timeclock system is further configured:
to receive the time capture event from a mobile device associated with the employee, wherein the time capture event includes location data that identifies a geographical location of the mobile device.

13. The computer system of claim 12, wherein in determining whether the smart contract permits the time capture event, the blockchain timeclock system is further configured:
to determine whether the geographical location of the mobile device that sent the time capture event is within a permitted geographic area; and
responsive to determining that the geographical location is within a permitted geographic area, to permit the time capture event.

14. The computer system of claim 9, wherein in receiving the time capture event, the blockchain timeclock system is further configured:
to receive the time capture event from a mobile device associated with the employee, wherein the time capture event includes a current time.

15. The computer system of claim 14, wherein in determining whether the smart contract permits the time capture event, the blockchain timeclock system is further configured:
to determine whether the current time sent in the time capture event is within a permitted time window; and
responsive to determining that the current time is within the permitted time window, to permit the time capture event.

16. The computer system of claim 9, wherein the timekeeper service is associated with an account of an employer in the blockchain timeclock system, wherein the blockchain timeclock system is further configured:
to associate a URL address for the timekeeper service with the account of the employer in the blockchain timeclock system; and
to push a POST request to the timekeeper service, wherein the POST request comprises a JSON object that includes the time capture event.

17. A computer program product for tracking work hours for employees within a blockchain timeclock system, the computer program product comprising:
a non-transitory computer readable storage media;
program code, stored on the computer readable storage media, for receiving a time capture event that identifies an account of an employee in the blockchain timeclock system;
program code, stored on the computer readable storage media, for recording the time capture event in a timeclock blockchain;
program code, stored on the computer readable storage media, for determining whether a smart contract recorded within the timeclock blockchain permits the time capture event;
program code, stored on the computer readable storage media, for updating a state of the account of the employee in the blockchain timeclock system to reflect the time capture event in response to determining that the smart contract permits the time capture event; and
program code, stored on the computer readable storage media, for communicating the time capture event to a timekeeper service to record timeclock information for the employee in response to determining that the smart contract permits the time capture event.

18. The computer program product of claim 17, wherein the program code for receiving the time capture event further comprises:
program code for program code, stored on the computer readable storage media, for receiving the time capture event from a mobile device associated with the employee, wherein the time capture event includes a mobile signature that uniquely identifies the mobile device.

19. The computer program product of claim 18, wherein the program code for determining whether the smart contract permits the time capture event further comprises:
program code, stored on the computer readable storage media, for determining whether the mobile signature for the mobile device that sent the time capture event is associated with the account of the employee in the blockchain timeclock system; and
program code, stored on the computer readable storage media, for permitting the time capture event in response to determining that the mobile signature is associated with the account of the employee.

20. The computer program product of claim 17, wherein the program code for receiving the time capture event further comprises:
program code, stored on the computer readable storage media, for receiving the time capture event from a mobile device associated with the employee, wherein the time capture event includes location data that identifies a geographical location of the mobile device.

21. The computer program product of claim 20, wherein the program code for determining whether the smart contract permits the time capture event further comprises:
program code, stored on the computer readable storage media, for determining whether the geographical location of the mobile device that sent the time capture event is within a permitted geographic area; and
program code, stored on the computer readable storage media, for permitting the time capture event in response to determining that the geographical location is within a permitted geographic area.

22. The computer program product of claim 17, wherein the program code for receiving the time capture event further comprises:
program code, stored on the computer readable storage media, for receiving the time capture event from a mobile device associated with the employee, where in the time capture event includes a current time.

23. The computer program product of claim 22, wherein the program code for determining whether the smart contract permits the time capture event further comprises:
program code, stored on the computer readable storage media, for determining whether the current time sent in the time capture event is within a permitted time window; and
program code, stored on the computer readable storage media, for permitting the time capture event in response to determining that the current time is within the permitted time window.

24. The computer program product of claim 17, wherein the timekeeper service is associated with an account of an employer in the blockchain timeclock system, the computer program product further comprising:
program code, stored on the computer readable storage media, for associating a URL address for the timekeeper service with the account of the employer in the blockchain timeclock system; and
program code, stored on the computer readable storage media, for pushing a POST request to the timekeeper service, wherein the POST request comprises a JSON object that includes the time capture event.
